(19) United States
(12) Patent Application Publication
(10) Pub. No.: US 2010/0060597 A1
(43) Pub. Date: Mar. 11, 2010

(54) METHOD AND APPARATUS FOR DISPLAYING AND SELECTING ICONS ON A TOUCH SCREEN

(75) Inventors: Jun-ho Choi, Suwon-si (KR); Hye-jin Kim, Suwon-si (KR); Se-hyun Park, Suwon-si (KR); Na-ri Choi, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/486,113

(22) Filed: Jun. 17, 2009

(30) Foreign Application Priority Data
Sep. 10, 2008 (KR) 10-2008-0089320

(51) Int. Cl. G06F 3/041

(52) U.S. Cl. 345/173

(57) ABSTRACT

A touch screen including a display unit configured to display a plurality of icons. The touch screen may include a detection unit configured to detect a touch in one of a plurality of touch detection regions of the display unit wherein the touch detection regions comprise an icon portion on which one icon of the plurality of icons is displayed, and an adjacent portion which is adjacent to the icon portion. The touch screen may further include a control unit electrically connected to the display unit and the detection unit, the control unit configured to control display operations of the display unit, and configured to identify based on a received signal from the detection unit which touch detection region is touched and which one icon is displayed in the touched detection region.

### CROSS-REFERENCE TO RELATED PATENT APPLICATION

This application claims the benefit of Korean Patent Application No. 10-2008-0089320, filed on Sep. 10, 2008, in the Korean Intellectual Property Office, the entire contents of which is incorporated herein by reference.

### BACKGROUND OF THE INVENTION

1. Field of the Invention

The present invention relates to a touch screen, and more particularly, to an easy-to-use touch screen having touch-detecting regions extending around icons, and to methods related thereto.

2. Description of the Related Art

A touch screen is a device widely used in various fields including personal electronic devices, such as cellular phones, digital cameras, portable media players (PMP), etc., and industrial equipment, such as control screen interfaces of manufacturing machines in factories.

For example, touch screens have recently begun to be used in digital cameras for increasing user convenience. During a photographing operation using a digital camera including a touch screen, a user can confirm a scene to capture an image thereof. Furthermore, a user can select and execute items from an operating menu of a digital camera by manipulating the touch screen with a finger or a stylus.

Manufacturers of electronic devices having touch screens have been enhancing arrangement of menus displayed on touch screens such that users can operate the electronic devices more conveniently. The more complex an electronic device, the more menus are displayed on a touch screen of the device. Thus, the manufacturers are continually trying to increase menu recognition and operating convenience by enhancing a graphic user interface (GUI) of their electronic devices.

However, portable electronic devices usually include mini touch screens, and thus operating the touch screens may not be easy. The latest portable electronic devices have many functions for their sizes, and thus, various complicated menus are displayed on touch screens to support the functions. As a result, sizes of menu buttons and/or icons displayed on touch screens and intervals therebetween become smaller, and thus considerable accuracy is required to operate menus displayed on the touch screens. In other words, users may easily make mistakes while operating the touch screen, and thus a function demanded by the user may not be executed correctly. In particular, in the case of operating a touch screen by using a finger instead of a stylus, accuracy of operation decreases further.

### SUMMARY OF THE INVENTION

The present invention provides methods and apparatuses for displaying and selecting icons on a touch screen.

A touch screen including a display unit configured to display a plurality of icons. The touch screen may include a detection unit configured to detect a touch in one of a plurality of touch detection regions of the display unit wherein the touch detection regions comprise an icon portion on which one icon of the plurality of icons is displayed, and an adjacent portion which is adjacent to the icon portion. The touch screen may further include a control unit electrically connected to the display unit and the detection unit, the control unit configured to control display operations of the display unit, and configured to identify based on a received signal from the detection unit which touch detection region is touched and which one icon is displayed in the touched detection region.

The display unit may be further configured to display the plurality of icons across the display unit in a predetermined direction. The touch detecting region may extend in a direction across the predetermined direction in which the plurality of icons are displayed.

The control unit may further be configured to determine the portion of the touch detecting region in which the touch was received based on the received signal, and configured to control the display unit to display an assistant icon in the portion of the touch detection region in which the touch is detected.

The control unit may be further configured to determine a size of the touch based on the received signal and may be configured to control the display unit to display the size of the assistant icon in proportion to the determined size of the touch.

The control unit may be further configured to control the display unit to display the assistant icon in the adjacent portion of the touch detection region.

The assistant icon may comprise text information regarding the icon. The assistant icon may be displayed to partially overlap the identified one icon. The assistant icon has a semi-transparent color such that the identified one icon is visible through the display of the assistant icon.

The control unit may be further configured to control the display unit to modify the identified one icon. The control unit may be further configured to increase the size of the identified one icon. The control unit may be further configured to change the colors of the identified one icon.

The touch screen may further comprise a detection region setup unit configured to determine based on a signal received from the detection unit the contact area of a finger contacting the touch screen and may be configure to control the display unit to display the size of the touch detecting region based on the contact area.

The icons may be displayed along an arc, and the touch detecting regions may extend in a radial direction of the arc.

A method for displaying and selecting icons on a touch screen may include displaying a plurality of icons on the touch screen in touch detection regions. The touch detection regions may comprise an icon portion on which one icon of the plurality of icons is displayed, and an adjacent portion which is adjacent to the icon portion. The method may include detecting a touch on the touch screen. The method may further include identifying based on the touch which touch detection region is touched and which one icon is displayed in the touched detection region.

Displaying a plurality of icons may further comprise displaying the plurality of icons on the touch screen in a direction across the touch screen wherein the touch detection regions extend across the direction.

The method may further comprise displaying an assistant icon in the portion of the touch detection region in which the touch is detected.

The method may further comprise determining a size of the touch, and displaying the size of the assistant icon in proportion to the determined size of the touch.

Displaying an assistant icon may further comprise displaying an assistant icon in the adjacent portion of the touch detection region.

The assistant icon may include text information regarding the icon.

Displaying the assistant icon may further comprise displaying the assistant icon with a semi-transparent color such that the identified one icon is visible through the display of the assistant icon.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating components of a example of a digital camera including a touch screen according to an embodiment of the present invention;

FIG. 2 is a diagram illustrating an example of operations of the touch screen of FIG. 1, according to an embodiment of the present invention;

FIG. 3 is a diagram illustrating another example of operations of the touch screen of FIG. 2, according to an embodiment of the present invention;

FIG. 4 is a diagram illustrating an example of operations of a touch screen according to another embodiment of the present invention;

FIG. 5 is a diagram illustrating an example of operations of a touch screen according to another embodiment of the present invention;

FIG. 6 is a diagram illustrating an example of operations of a touch screen according to another embodiment of the present invention;

FIG. 7 is a diagram illustrating an example of operations of a touch screen according to another embodiment of the present invention;

FIG. 8 is a diagram illustrating an example of operations of a touch screen according to another embodiment of the present invention; and

FIG. 9 is a diagram illustrating an example of operations of a touch screen according to another embodiment of the present invention;

### DETAILED DESCRIPTION OF THE INVENTION

Exemplary embodiments of the present invention will now be described with reference to the attached drawings.

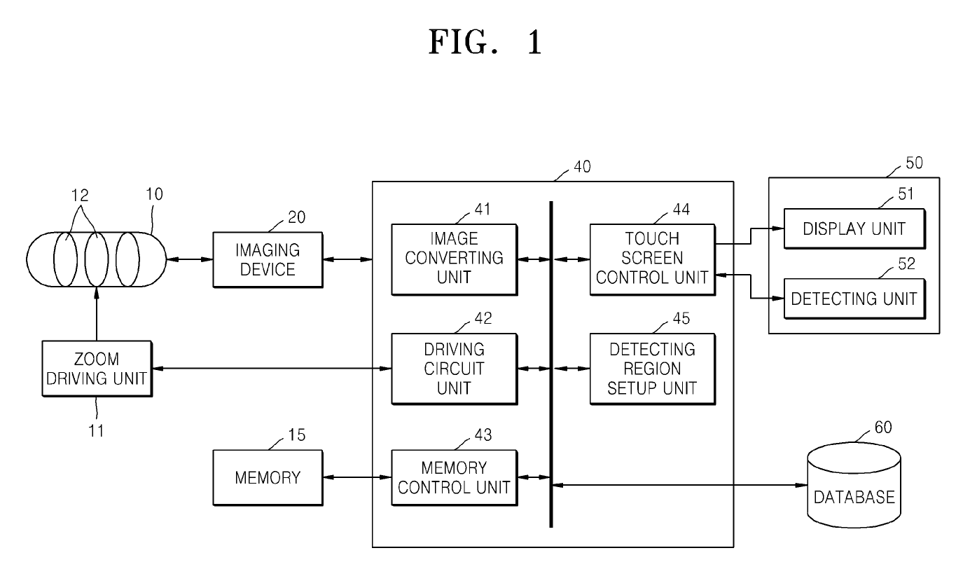

FIG. 1 is a block diagram illustrating components of an example of a digital camera including a touch screen 50 according to an embodiment of the present invention. Referring to FIG. 1, the touch screen 50 displays captured images and/or operating menus, and includes a display unit 51, a detecting unit 52, and a touch screen control unit 44.

The digital camera including the touch screen 50 illustrated in FIG. 1 includes an imaging device 20 capturing an image and converting the image to an electrical signal, an image converting unit 41 converting electrical signals from the imaging device 20 to image data, and a camera control unit 40.

A zoom lens unit 10 disposed in front of the imaging device 20 includes a plurality of lenses 12 in order to form an image on an image plane of the imaging device 20 by using external incident light. The lenses 12 are disposed such that intervals therebetween can be adjusted. When the intervals between the lenses 12 are adjusted, the zooming power of the zoom lens unit 10 is changed.

Positions of the lenses 12 may be changed as the lenses 12 are driven by a zoom driving unit 11 having a driving mechanism such as a zoom motor. The zoom driving unit 11 operates when a control signal is applied from a driving circuit unit 42 of the control unit 40. Therefore, the zoom lens unit 10 can be driven to have a desired zooming step.

The imaging device 20 includes a photo-electric converting device, such as a charge coupled device (CCD) or a complementary metal oxide semiconductor (CMOS), and converts light, which is incident to the imaging device 20 through the zoom lens unit 10, to electrical signals. An operation of converting incident light to electrical signals may include a plurality of sub-operations, such as converting the incident light to analog signals and converting the analog signals to digital signals.

The camera control unit 40 is electrically connected to the imaging device 20, the zoom driving unit 11, a memory 15, the touch screen 50, etc., and either exchanges control signals with such components for controlling operations of each of the components or processes data. The camera control unit 40 includes the image converting unit 41, the driving circuit unit 42, a touch panel control unit 44, a detecting region setup unit 45, and a memory control unit 43 controlling data storage with respect to the memory 15.

The camera control unit 40 may be embodied as a printed circuit board including a microchip, and components of the camera control unit 40 may be embodied as software and/or circuits integrated in the camera control unit 40.

In the embodiment illustrated in FIG. 1, the touch screen control unit 44 controlling the touch screen 50 is integrated in the camera control unit 40. However, the present invention is not limited thereto. In other words, the touch screen control unit 44 may be embodied as a microchip or a circuit panel independent from the camera control unit 40 and/or may be integrated in the touch screen 50.

The memory control unit 43 controls recording image data in the memory 15 and reading image data and/or setup information recorded in the memory 15. The memory 15 may be a semiconductor memory device such as synchronous dynamic random access memory (SDRAM), and may function as a recording medium storing data of captured images.

A database 60 stores data regarding a relationship between areas that a finger contacts the touch screen 50 and size of a touch detecting region to be displayed by the display unit 51 according to sizes of various fingers. The detecting region setup unit 45 may set up size of an icon detecting region corresponding to an area of a finger contacting the touch screen 50 based on data recorded in the database 60, wherein the area is detected by the touch screen 50.

The touch screen 50 displays images captured by the imaging device 20, and detects contact on the surface of the touch screen 50 and generates a signal corresponding to the detected position. The touch screen 50 is an alternative input device to a keyboard and/or a mouse, and desired operations can be performed by touching the surface of the touch screen 50 with a finger or a stylus. Thus, operations can be performed intuitively in a graphic user interface (GUI) environment.

The touch screen 50 may include the display unit 51 displaying images including icons, and may include the detecting unit 52 detecting contact on the surface of the touch screen 50. The display unit 51 may include a liquid crystal display (LCD), an organic light emitting diode (OLED), or the like.

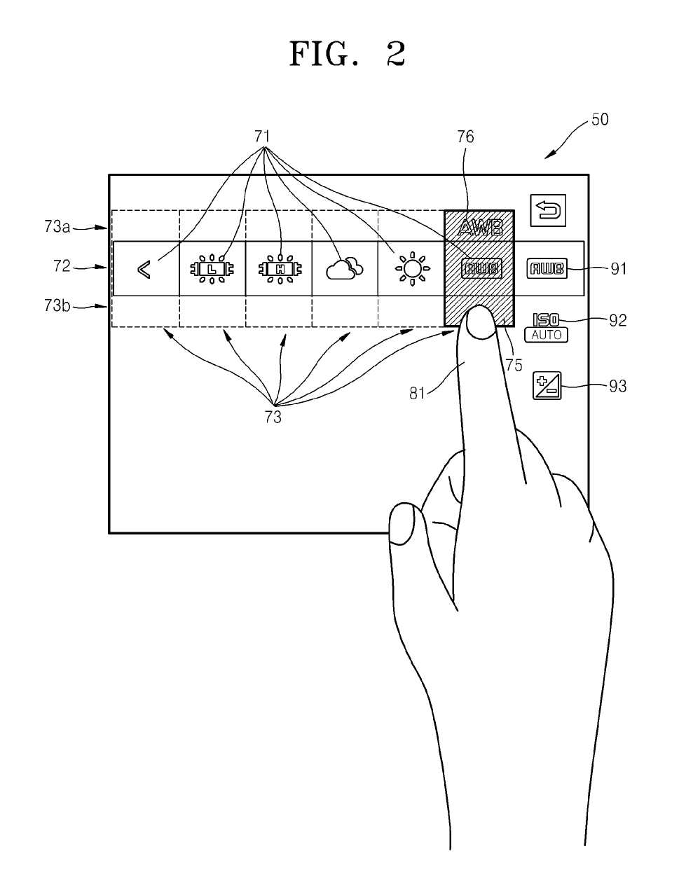

The detecting unit 52 may be installed on the surface of the display unit 51 to detect contact on the surface of the display unit 51. Various technologies, such as a resistance detecting device, a capacity detecting device, a surface acoustic wave detecting device, an infrared ray (IR) detecting device, an optical detecting device, etc., may be used in the detecting unit 52. The detecting unit 52 is controlled by the touch screen control unit 44 to detect contact in a touch detecting region including regions adjacent to icons displayed on the display unit 51. The touch detecting regions will be described below by referring to FIG. 2.

The touch screen control unit 44 is electrically connected to the display unit 51 and may control the display unit 51. Furthermore, the touch screen control unit 44 is electrically connected to the detecting unit 52 and may recognize selection of an icon existing in a region, determined as contacted by receiving a signal. The selection of icons will be described below by referring to FIG. 2.

FIG. 2 is a diagram illustrating an example of operations of the touch screen 50 of FIG. 1, according to an embodiment of the present invention.

A plurality of subordinate icons 71 instructing a user to select desired functions are displayed on the touch screen 50, according to the present embodiment. The subordinate icons 71 are arranged apart from each other in a horizontal direction with respect to the touch screen 50. Furthermore, the subordinate icons 71 are disposed on an icon portion 72. As described above, the touch screen 50 includes the display unit and the detecting unit. The icons 71 are displayed in the display unit, and the detecting unit detects the contact related to the icons 71.

Category icons 91, 92, and 93 are disposed in a vertical direction on the right edge of the touch screen 50. FIG. 2 shows an operation of the touch screen 50 when a user selects a white balance icon 91 from among the category icons 91, 92, and 93. When the white balance icon 91 is selected, the subordinate icons 71 of the white balance icon 91 are displayed in a horizontal direction extending from the white balance icon 91.

A touch detecting region 73 capable of detecting contact on the surface of the touch screen 50 includes the icon portion 72, and extends across the touch screen 50 in a direction substantially perpendicular to a direction in which the subordinate icons 71 are displayed. In the embodiment illustrated, the touch detecting region 73 extends in a vertical direction on the touch screen 50.

In the touch detecting region 73, upper and lower extension portions 73a and 73b extend from the top end and the bottom end of the icon portion 72, respectively, to extend a touch detecting area when a user touches the surface of the touch screen 50 with a finger 81. Therefore, even if the subordinate icons 71 are relatively small, contact of the finger 81 can be detected in the upper and lower extension portions 73a and 73b adjacent to the icon portion 72 and the subordinate icons 71, and thus a user can operate the touch screen 50 conveniently. The upper and lower extension portions 73a and 73b can be referred to as an adjacent portion.

When a signal indicating that the touch detecting region 73 is touched is applied to the touch screen control unit 44 of FIG. 1, the touch screen control unit 44 may determine that the subordinate icon 71 corresponding to the touch-detected area of the touch detecting region 73 is selected. The camera control unit 40 of FIG. 1 may execute a function corresponding to the selected subordinate icon 71 in response to a signal from the touch screen control unit 44.

The touch screen control unit 44 may display an assistant icon 75 on the touch detecting region 73 in which a touch is detected. For convenience of explanation, the touch detecting region 73 is illustrated with broken lines in FIG. 2, but the broken lines may not be displayed on the touch screen 50. The user may only be able to detect the icon portion 72. The assistant icon 75 informs a user which of the subordinate icons 71 is selected by the finger 81 of the user and may show the size of the portion of the touch detecting region 73 in which a touch can be detected.

The size of the assistant icon 75 may correspond to the touch detecting region 73 as illustrated in FIG. 2. However, the present invention is not limited thereto, and the assistant icon 75 may have various sizes and shapes. The assistant icon 75 may be larger or smaller than the touch-detected area of the touch detecting region 73, and the assistant icon 75 may either partially overlap the icon portion 72 or not overlap the icon portion 72.

The assistant icon 75 may include text information 76 describing the selected subordinate icon 71. In FIG. 2, the text information 76 is displayed at a position of the assistant icon 75 corresponding to the upper extension portion 73a of the touch detecting region 73. A user can conveniently and precisely recognize the selected subordinate icon 71 from the text information 76 of the assistant icon 75.

The assistant icon 75 may have a semi-transparent color such that the subordinate icon 71 overlapped by the assistant icon 75 is visible. Thus, a user can simultaneously confirm the currently selected subordinate icon 71 and recognize the size of the touch detecting region 73 via the assistant icon 75.

A user may drag-touch the touch screen 50. Drag-touching refers to a method of touching a touch screen in which a user touches the touch screen with either a finger or a stylus and moves the finger or the stylus over the touch screen 50. When a user drag-touches the touch screen 50, the assistant icon 75 is displayed on the subordinate icon 71 following the position of the finger 81 of a user. Therefore, it is recognized by a user that the assistant icon 75 moves after the finger 81, and thus operating the touch screen 50 may be more convenient and effective.

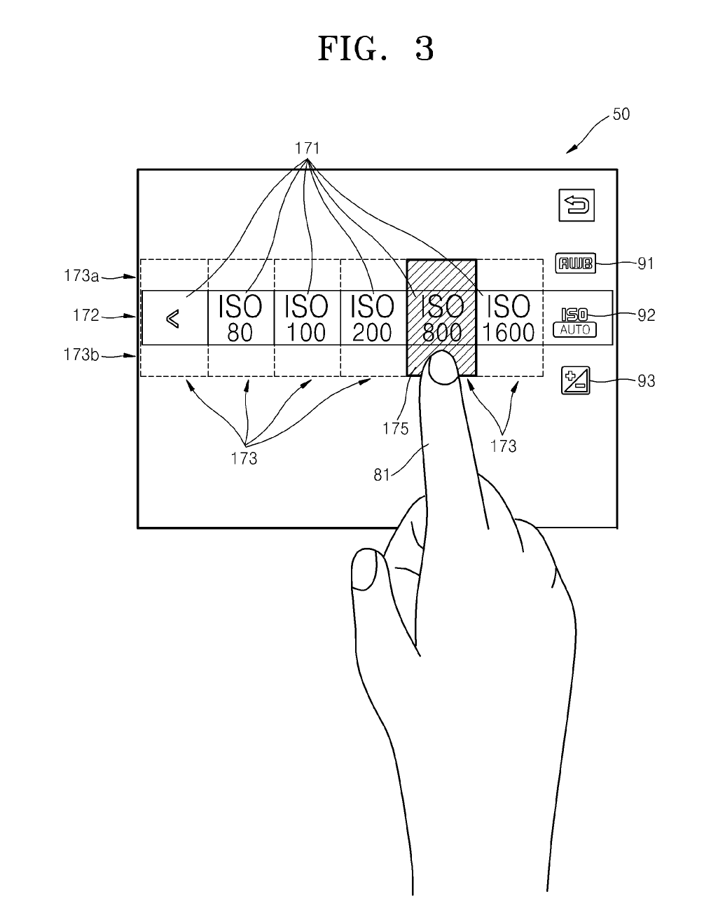

FIG. 3 is a diagram illustrating another example of the operation of the touch screen 50 of FIG. 2, according to an embodiment of the present invention. FIG. 3 illustrates an operation of the touch screen 50 when an ISO setup icon 92 located below the white balance icon 91 in FIG. 2 is selected. When the ISO setup icon 92 is selected, subordinate icons 171 corresponding to the ISO setup icon 92 are displayed in a substantially horizontal direction extending from the ISO setup icon 92. In FIG. 3, an icon portion 172 in which the subordinate icons 171 are displayed, a touch detecting region 173 including upper and lower extension regions 173a and 173b adjacent to the subordinate icons 171, and an assistant icon 175 are all displayed downward and newly arranged to correspond to a position of the ISO setup icon 92.

As described above, the position of the icon detection region 173 of the touch screen 50 according to an embodiment of the present invention is not limited to a specific position of the touch screen 50, and may be changed according to the subordinate icons 171 currently displayed. Therefore, as illustrated in FIG. 2, when one of the category icons 91, 92, and 93 is selected, subordinate icons 171 corresponding to the selected category icon are displayed in a substantially horizontal direction extending from the selected category icon in the right part of the touch screen 50, and touch detecting regions are newly configured above and below the subordinate icons.

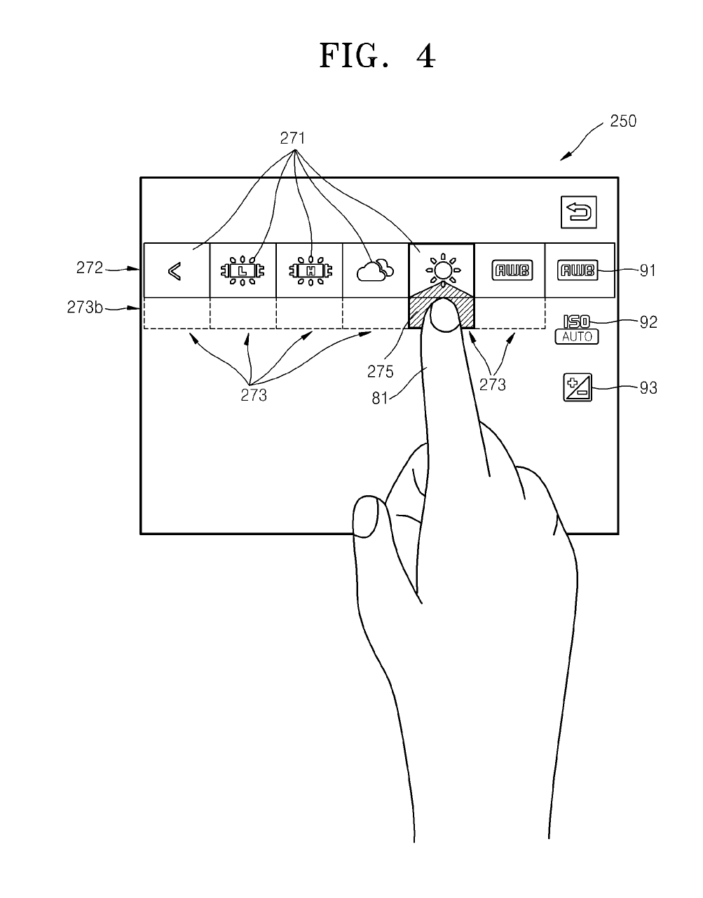

FIG. 4 is a diagram illustrating an example of operations of a touch screen 250 according to another embodiment of the present invention.

Referring to FIG. 4, a plurality of subordinate icons 271, which provide information to a user such that the user can select a function to execute, are displayed on the touch screen 250 according to the present embodiment. The subordinate icons 271 are arranged apart from each other in a horizontal direction with respect to the touch screen 250. The subordinate icons 271 are displayed in an icon portion 272.

Unlike the embodiment illustrated in FIG. 2, a touch detecting region 273 does not include the icon portion 272, in which the subordinate icons 271 are displayed, according to the present embodiment. In the embodiment illustrated, the touch detecting region 273 only includes a bottom extension portion 273b adjacent to the subordinate icons 271. Thus, the touch screen 250 does not recognize a touch of a finger 81 of a user with respect to the subordinate icons 271, and only recognizes a touch in the extension portion 273b. The bottom extension portion 273b can be referred to as an adjacent portion.

A user does not have to precisely touch a position in which the subordinate icons 271 are displayed to select one of the subordinate icons 271, and only has to touch the touch detecting region 273 adjacent to the subordinate icons 271. Thus, the finger 81 does not have to cover the subordinate icons 271 when a user selects one of the subordinate icons 271 with the finger 81.

An assistant icon 275 is displayed on the portion of the touch detecting region 273 in which a touch of the finger 81 is detected. The assistant icon 275 extends upward to overlap a part of the icon portion 272. Therefore, the size of the assistant icon 275 is larger than that of the touch detecting region 273. The assistant icon 275 can both indicate which subordinate icon 271 the finger 81 is selecting and the size of the touch detecting region 273.

The assistant icon 275 may have a semi-transparent color such that the subordinate icon 271 overlapped by the assistant icon 275 is visible. Thus, a user can simultaneously confirm the currently selected subordinate icon 271 and recognize the size of the touch-detected area of the touch detecting region 273 via the assistant icon 275.

A user may drag-touch the touch screen 250. When a user drag-touches the touch screen 250, the assistant icon 275 is displayed on the subordinate icon 271 corresponding to a position of the finger 81 of a user. Therefore, it is recognized by a user that the assistant icon 275 moves after the finger 81, and thus operating the touch screen 250 may be more convenient and effective.

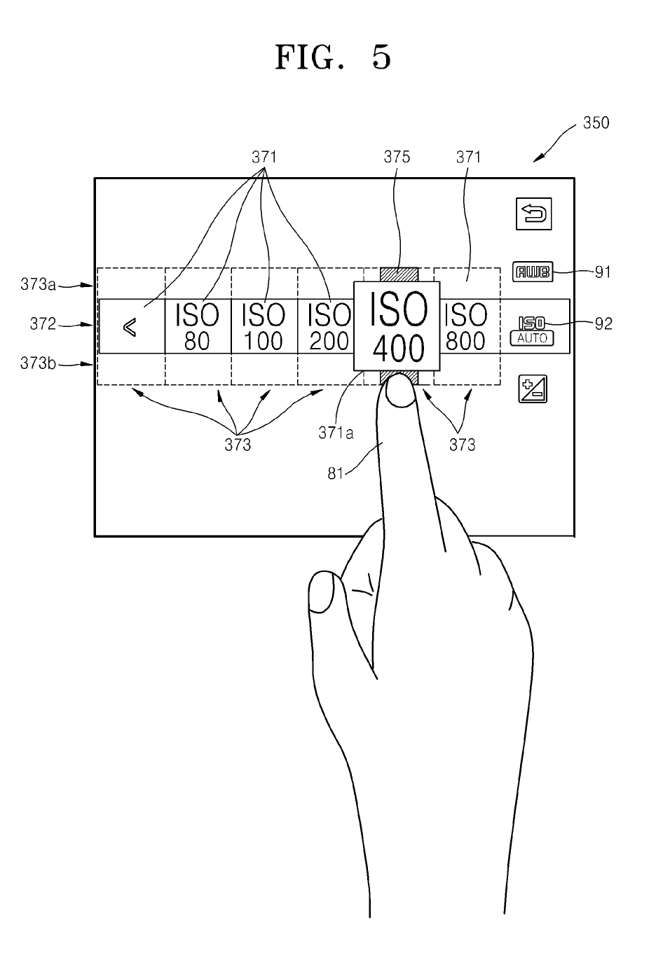

FIG. 5 is a diagram illustrating an example of operations of a touch screen 350 according to another embodiment of the present invention. FIG. 5 illustrates an operation of the touch screen 350 when an ISO setup icon 92 located below a white balance icon 91 is selected.

When the ISO setup icon 92 is selected, a plurality of subordinate icons 371 corresponding to the ISO setup icon 92 are displayed in a horizontal direction extending from the ISO setup icon 92. The plurality of subordinate icons 371 are arranged apart from each other in a horizontal direction along the touch screen 350. Furthermore, the subordinate icons 371 are displayed in an icon portion 372.

A touch detecting region 373 capable of detecting contact on the surface of the touch screen 350 includes the icon portion 372, and extends across the touch screen 350 in a direction crossing the direction in which the subordinate icons 371 are disposed. In other words, the touch detecting region 373 extends in a substantially vertical direction on the touch screen 350.

In the touch detecting region 373, upper and lower extension portions 373a and 373b extend from the top end and the bottom end of the icon portion 372, respectively, to extend a touch detecting area when a user touches the surface of the touch screen 350 with a finger 81. Therefore, even if the subordinate icons 371 are relatively small, contact of the finger 81 is also detected in the upper and lower extension portions 373a and 373b adjacent to the icon portion 372 and the subordinate icons 371, and thus a user can operate the touch screen 350 conveniently. The extension portions 373a and 373b can be referred to as an adjacent region.

An assistant icon 375 is displayed in a portion of the touch detecting region 373 in which contact of the finger 81 is detected. The assistant icon 375 is displayed in the upper and lower extension portions 373a and 373b. However, the assistant icon 375 may be displayed across the icon portion 372 to partially overlap the subordinate icon 371 corresponding to the touch-detected area of the touch detecting region 373. The assistant icon 375 informs a user which of the subordinate icons 371 is selected by the finger 81 and shows the size of the portion of the touch detecting region 373 in which a touch can be detected.

The selected subordinate icon 371 may be changed to a magnified icon 371 a bigger in size than the selected subordinate icon 371. Even if the size of the displayed subordinate icon 371 is small, the subordinate icon 371 is changed to the magnified icon 371 a having an increased size when the subordinate icon 371 is selected by a user. Thus, the user can precisely recognize the subordinate icon 371 at a position where the finger 81 is. In embodiments, the selected subordinate icon 371 may be displayed with changed colors and/or be magnified.

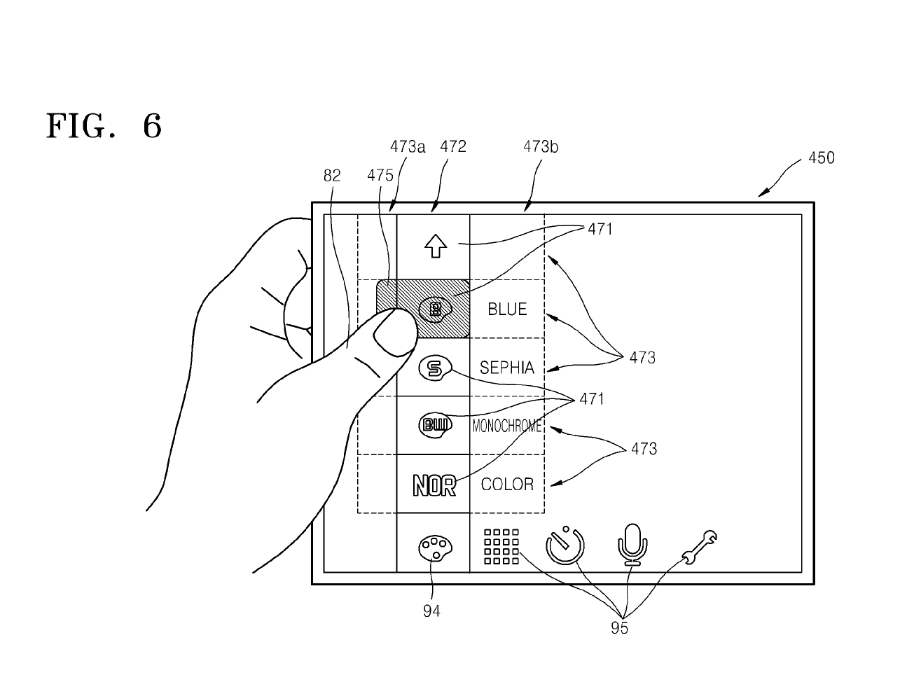

FIG. 6 is a diagram illustrating an example of operations of a touch screen 450 according to another embodiment of the present invention.

Referring to FIG. 6, a plurality of subordinate icons 471, which provide information to a user such that the user can select a function to execute, are displayed on the touch screen 450 according to the present embodiment. The plurality of subordinate icons 471 are arranged apart from each other in a vertical direction with respect to the touch screen 450. The icons 471 are displayed in an icon portion 472.

Category icons 94 and 95 are displayed in a horizontal direction along the bottom edge of the touch screen 450. FIG. 6 illustrates an operation of the touch screen 450 when a user selects a filter setup icon 94 from among the category icons 94 and 95. When the filter setup icon 94 is selected, subordinate icons 471 corresponding to the filter setup icon 94 are displayed in a vertical direction extending upward from the filter setup icon 94.

A touch detecting region 473 capable of detecting contact on the surface of the touch screen 450 includes the icon portion 472, and extends across the touch screen 450 in a direction crossing the direction in which the subordinate icons 471 are disposed. In embodiments, the touch detecting region 473 extends in a substantially horizontal direction on the touch screen 450.

In the touch detecting region 473, left and right extension portions 473a and 473b extend from the left end and the right end of the icon portion 472, respectively, to extend a touch detecting area when a user touches the surface of the touch screen 450 with a finger 82. Therefore, even if the subordinate icons 471 are relatively small, contact of the finger 82 is also detected in the left and right extension portions 473a and 473b adjacent to the icon portion 472 and the subordinate icons 471, and thus a user can operate the touch screen 450 conveniently. The extension portions 473a and 473b can be referred to as adjacent portions.

The touch screen 450 shown in FIG. 6 can also be controlled by the touch screen control unit 44 of FIG. 1. The touch screen control unit 44 may recognize that the subordinate icon 471 corresponding to the touch-detected area of the touch detecting region 473 is selected, and may execute a function corresponding to the selected subordinate icon 471.

The touch screen control unit 44 may display an assistant icon 475 on the touch-detected area of the touch detecting region 473 in which a touch is detected. For convenience, the touch detecting region 473 is displayed with broken lines in FIG. 6, but a user may only be able to recognize pictures within the icon portion 472. The assistant icon 475 informs a user which of the subordinate icons 471 is selected by the finger 82 and shows the size of the touch-detected area of the touch detecting region 473.

The size of the assistant icon 475 is smaller than that of the touch detecting region 473. However, the present invention is not limited thereto, and the assistant icon 475 may have various sizes and shapes. In other words, the assistant icon 475 may be larger or smaller than the touch detecting region 473, and the assistant icon 475 may either partially overlap the icon portion 472 or not overlap the icon portion 472.

The assistant icon 475 may include text information 476 describing the selected subordinate icon 471. In FIG. 6, the text information 476 is displayed at a position of the assistant icon 475 corresponding to the right extension portion 473b of the touch detecting region 473. A user can conveniently and precisely recognize the selected subordinate icon 471 from the text information 476 of the assistant icon 475.

The assistant icon 475 may have a semi-transparent color such that the subordinate icon 471 overlapped by the assistant icon 475 is visible. Thus, a user can confirm the currently selected subordinate icon 471 and recognize the size of the touch detecting region 473 via the assistant icon 475 simultaneously.

A user may drag-touch the touch screen 450. When a user drag-touches the touch screen 450, the assistant icon 475 is displayed on the subordinate icon 471 following the position of the finger 82 of a user. Therefore, it is recognized by a user that the assistant icon 475 moves after the finger 82, and thus operating the touch screen 450 may be more convenient and effective.

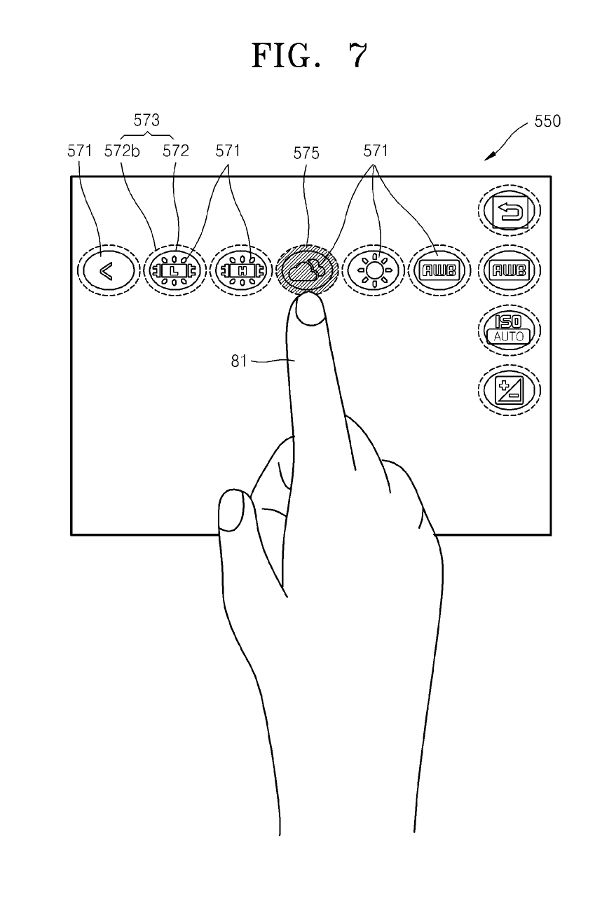

FIG. 7 is a diagram illustrating an example of operations of a touch screen 550 according to another embodiment of the present invention.

Referring to FIG. 7, a plurality of subordinate icons 571 instructing a user to select desired functions are shown on the touch screen 550 according to the present embodiment. The plurality of subordinate icons 571 are arranged apart from each other in a horizontal direction with respect to the touch screen 550. Furthermore, the subordinate icons 571 are displayed in an icon portion 572.

A touch detecting region 573 capable of detecting contact on the surface of the touch screen 550 includes the icon portion 572 and an adjacent portion 572b around the icon portion 572. According to the present embodiment, the touch detecting region 573 is formed to have a circular shape to surround the icon portion 572. However, the present invention is not limited thereto, and the touch detecting region 573 may have various polygonal shapes such as a triangle or rectangle.

The touch detecting region 573 expands a region in which touch can be detected when a user touches the surface of the touch screen 550 with a finger 81 in order to select one of the subordinate icons 571. Therefore, even if the subordinate icon 571 is relatively small, contact of the finger 81 is also detected outside the icon portion 572, and thus a user can operate the touch screen 550 conveniently.

An assistant icon 575 is displayed in the touch detecting region 573 in which contact of the finger 81 is detected. The assistant icon 575 is formed to have a size corresponding to the touch detecting region 573. The assistant icon 575 informs a user which of the subordinate icons 571 is selected by the finger 81 of the user and shows a size of the touch detecting region 573 in which a touch can be detected.

The assistant icon 575 may have a semi-transparent color such that the subordinate icon 571 overlapped by the assistant icon 575 is visible. Thus, a user can confirm the currently selected subordinate icon 571 and recognize the size of the touch detecting region 573 via the assistant icon 575 simultaneously.

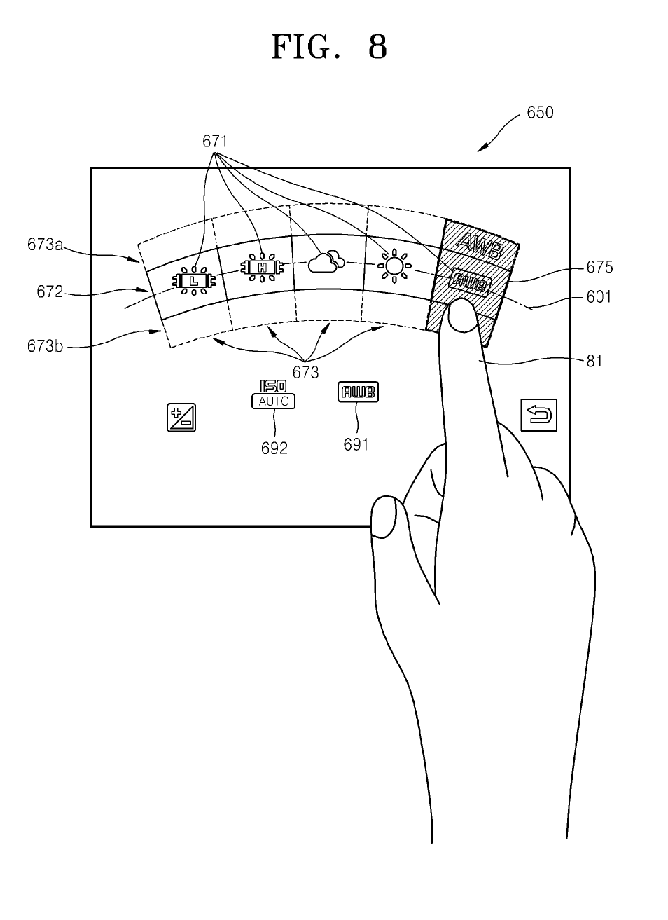

FIG. 8 is a diagram illustrating an example of operations of a touch screen 650 according to another embodiment of the present invention.

Referring to FIG. 8, a plurality of subordinate icons 671 instructing a user to select desired functions are successively arranged along a curve on the touch screen 650 according to the present embodiment. In other words, the subordinate icons 671 are disposed in an icon portion 672 defined along an arc 601 shown in a broken line.

FIG. 8 illustrates an operation of the touch screen 650 when a white balance icon 691 is selected from among category icons 691 and 692, disposed in a lower part of the touch screen 650. When the white balance icon 691 is selected, subordinate icons 671 corresponding to the white balance icon 691 are displayed along the arc 601.

A touch detecting region 673 capable of detecting contact on the surface of the touch screen 650 includes the icon portion 672, and extends in a direction crossing the direction in which the subordinate icons 671 are disposed. In other words, the touch detecting region 673 extends across the arc 601 in a radial direction of the arc 601.

In the touch detecting region 673, outward and inner extension portions 673a and 673b extend outward and inward from the icon portion 672, respectively, to extend a touch detecting area when a user touches the surface of the touch screen 650 with a finger 81. Therefore, even if the subordinate icons 671 are relatively small, a touch of the finger 81 is also detected in the outward and inward extension portions 673a and 673b adjacent to the icon portion 672 and the subordinate icons 671, and thus a user can operate the touch screen 50 conveniently. The extension portions can be referred to as adjacent portions.

An assistant icon 675 is displayed on the touch detecting region 673 in which touch is detected. For convenience of explanation, the touch detecting region 673 is also illustrated by broken lines in FIG. 8, but a user may only be able to recognize pictures within the icon portion 672. The assistant icon 675 informs a user which of the subordinate icons 671 is selected by the finger 81 and shows the size of the touch detecting region 673.

The size of the assistant icon 675 corresponds to the touch detecting region 673. However, the present invention is not limited thereto, and the assistant icon 675 may have various sizes and shapes. In other words, the assistant icon 675 may be either larger or smaller than the touch detecting region 673, and the assistant icon 675 may either partially overlap the icon portion 672 or not overlap the icon portion 672.

The assistant icon 675 may have a semi-transparent color such that the subordinate icon 671 overlapped by the assistant icon 675 is visible. Thus, a user can confirm the currently selected subordinate icon 671 and recognize the size of the touch detecting region 673 via the assistant icon 675 simultaneously.

A user may drag-touch the touch screen 650. When a user drag-touches the touch screen 650, the assistant icon 675 is displayed on the subordinate icon 671 following the position of the finger 81 of a user. Therefore, it is recognized by a user that the assistant icon 675 moves after the finger 81, and thus operating the touch screen 650 may be more convenient and effective.

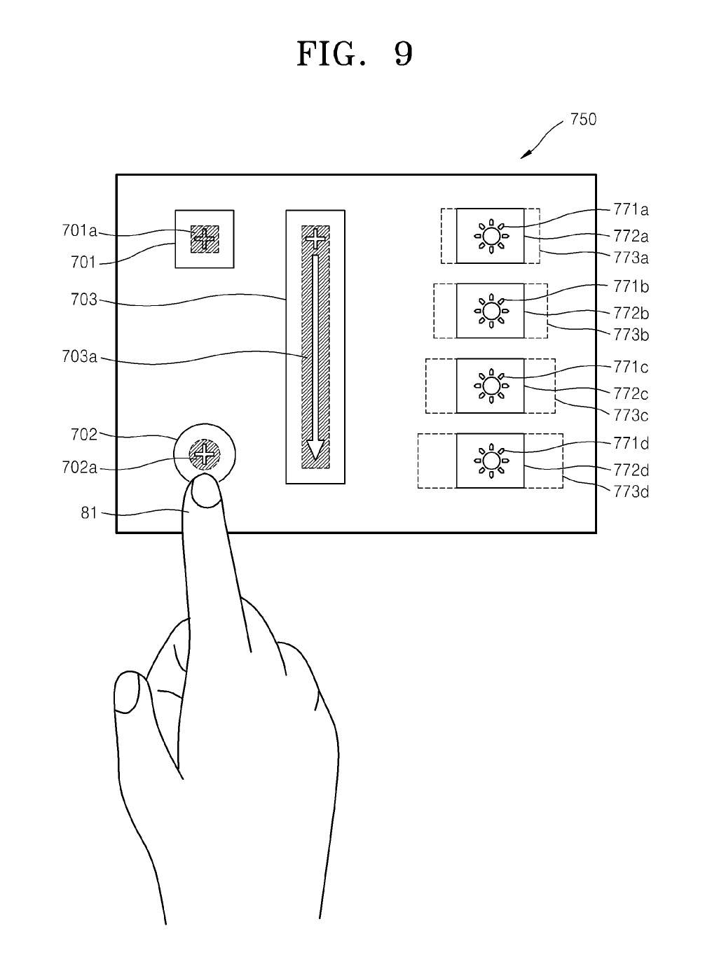

FIG. 9 is a diagram illustrating an example of operations of a touch screen 750 according to another embodiment of the present invention. FIG. 9 illustrates an operation of the touch screen 750 in which size of a touch detecting region is configured by the detecting region setup unit 45 of FIG. 1.

Area detecting regions 701, 702, and 703 detecting area of the finger 81 contacting the surface of the touch screen 750 are displayed on the touch screen 750 according to the present embodiment. The area detecting regions 701, 702, and 703 include reference icons 701a, 702a, and 703a, respectively. In FIG. 9, the area detecting regions 701, 702, and 703 are shown merely as an example of various possible arrangements of area detecting regions, and the number of area detecting regions is not limited to three.

The area detecting region 703, which is an area detecting region for drag-touching, is a region for detecting contact area of the finger 81 contacting the touch screen 750 when a user drag-touches the touch screen 750. Thus, detecting accuracy of average contact area according to operating patterns of a user operating the touch screen 750 can be further improved.

Icons 771a, 771b, 771c, and 771d, which are respectively disposed in icon portions 772a, 772b, 772c, and 772d, and touch detecting regions 773a, 773b, 773c, and 773d, which include the icons 771a, 771b, 771c, and 771d and extend outward from both sides of the icon portions 772a, 772b, 772c, and 772d, are displayed on the right side of the touch screen 750.

The size of each of the touch detecting regions 773a, 773b, 773c, and 773d increases in a downward direction to correspond to various finger sizes and contact areas which vary according to the finger sizes. In embodiments, the larger a finger size and area of the finger contacting the touch screen 750, the larger the touch detecting regions become.

When a user touches the reference icons 701a, 702a, and 703a of the area detecting regions 701, 702, and 703 with the finger 81, pixel signals corresponding to a position at which the touch is detected by the detecting unit 52 of FIG. 1 are transmitted to the touch screen control unit 44. The detecting region setup unit 45 can calculate contact area of the finger 81 contacting the reference icons 701a, 702a, and 703a based on the pixel signals transmitted to the touch screen control unit 44.

The database 60 of FIG. 1 stores data regarding relationships between contact areas of a finger contacting the surface of the touch screen 750 according to various finger sizes and sizes of the touch detecting regions 773a, 773b, 773c, and 773d to be displayed on the touch screen 750 in correspondence to the contact area. Thus, the detecting region setup unit 45 may select the touch detecting regions 773a, 773b, 773c, and 773d according to the contact area detected by the touch screen 750, based on the data stored in the database 60.

In a touch screen according to the present invention as described above, when a user touches an icon displayed on the touch screen, a region in which touch with respect to the icon can be detected is expanded. Thus, a user can operate the touch screen more conveniently, and a situation in which a user cannot recognize an icon covered by a finger of the user can be avoided.

Furthermore, size of the portion of the touch detecting region in which touch with respect to a currently selected icon is shown via an assistant icon, and text information describing a selected icon may be displayed. Thus, a touch screen can be used more conveniently.

Furthermore, when a user drag-touches a touch screen, that is, dragging a finger on the surface of the touch screen, an assistant icon moves after the finger in response to the dragging of the finger. Thus, convenience of operating a user interface on the touch screen can be improved significantly.

Furthermore, the detecting region setup unit changes the size of the touch detecting region in correspondence to contact area of a finger contacting the touch screen, so that the touch screen may correspond to various finger sizes.

For convenience, in the description above, the functionality described has been divided into a number of units; however, the number of units may vary and the functionality described above may be differently divided among the units, or the functionality described above may be implemented without units.

The various illustrative units described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMS, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A touch screen comprising:
a display unit configured to display a plurality of icons;
a detection unit configured to detect a touch in one of a plurality of touch detection regions of the display unit wherein the touch detection regions comprise an icon portion on which one icon of the plurality of icons is displayed, and an adjacent portion which is adjacent to the icon portion; and
a control unit electrically connected to the display unit and the detection unit, the control unit configured to control display operations of the display unit, and configured to identify based on a received signal from the detection unit which touch detection region is touched and which one icon is displayed in the touched detection region.

2. The touch screen of claim 1, wherein the display unit is further configured to display the plurality of icons across the display unit in a predetermined direction, and
wherein the touch detecting region extends in a direction across the predetermined direction in which the plurality of icons are displayed.

3. The touch screen of claim 1, wherein the control unit is further configured to determine the portion of the touch detecting region in which the touch was received based on the received signal, and configured to control the display unit to display an assistant icon in the portion of the touch detection region in which the touch is detected.

4. The touch screen of claim 3, wherein the control unit is further configured to determine a size of the touch based on the received signal and configured to control the display unit to display the size of the assistant icon in proportion to the determined size of the touch.

5. The touch screen of claim 3, wherein the control unit is further configured to control the display unit to display the assistant icon in the adjacent portion of the touch detection region.

6. The touch screen of claim 3, wherein the assistant icon comprises text information regarding the icon.

7. The touch screen of claim 3, wherein the assistant icon is displayed to partially overlap the identified one icon.

8. The touch screen of claim 3, wherein the assistant icon has a semi-transparent color such that the identified one icon is visible through the display of the assistant icon.

9. The touch screen of claim 1, wherein the control unit is further configured to control the display unit to modify the identified one icon.

10. The touch screen of claim 9, wherein the control unit is further configured to increase the size of the identified one icon.

11. The touch screen of claim 9, wherein the control unit is further configured to change the colors of the identified one icon.

12. The touch screen of claim 1, further comprising a detection region setup unit configured to determine based on a signal received from the detection unit the contact area of a finger contacting the touch screen and configured to change the size of the touch detecting region based on the determined contact area of the finger.

13. The touch screen of claim 1, wherein the icons are displayed along an arc, and the touch detecting regions extend in a radial direction of the arc.

14. A method for displaying and selecting icons on a touch screen, comprising:
displaying a plurality of icons on the touch screen in touch detection regions, the touch detection regions comprising an icon portion on which one icon of the plurality of icons is displayed, and an adjacent portion which is adjacent to the icon portion;
detecting a touch on the touch screen; and
identifying based on the touch which touch detection region is touched and which one icon is displayed in the touched detection region.

15. The method of claim 14, wherein displaying a plurality of icons further comprises:
displaying the plurality of icons on the touch screen in a direction across the touch screen wherein the touch detection regions extend across the direction.

16. The method of claim 14, further comprising:
displaying an assistant icon in the portion of the touch detection region in which the touch is detected.

17. The method of claim 16, further comprising:
determining a size of the touch; and
displaying the size of the assistant icon in proportion to the determined size of the touch.

18. The method of claim 16, wherein displaying an assistant icon further comprises:
displaying an assistant icon in the adjacent portion of the touch detection region.

19. The method of claim 16, wherein the assistant icon comprises text information regarding the icon.

20. The method of claim 16, wherein displaying the assistant icon further comprises:
displaying the assistant icon with a semi-transparent color such that the identified one icon is visible through the display of the assistant icon.
